(19) United States
(12) Patent Application Publication
(10) Pub. No.: US 2013/0311327 A1
(43) Pub. Date: Nov. 21, 2013

(54) Wish list for social networking site

(71) Applicants: Reza Tehrani, Bloomington, MN (US); Leila Taghizadeh, Bloomington, MN (US)

(72) Inventors: Reza Tehrani, Bloomington, MN (US); Leila Taghizadeh, Bloomington, MN (US)

(21) Appl. No.: 13/476,194

(22) Filed: May 21, 2012

(51) Int. Cl. G06Q 30/02

(52) U.S. Cl. 705/26.8

(57) ABSTRACT

Certain embodiments of the present disclosure include a wish list for a social networking site. In one embodiment, a method includes providing a first user interface having a wish list button. Upon an actuation of the wish list button, a second user interface having a wish list form is provided. Information is entered into the wish list form, and one or more vendor links that correspond to the information are identified. An electronic message that includes the one or more vendor links and the information entered into the wish list form is generated. In certain situations, a child enters the information into the wish list form, and the electronic message is sent to a parent of the child.

### BACKGROUND

Social networking sites are commonly used for members to exchange information. For example, members may exchange pictures, textual messages, videos, and any other type of information. The members may join a site and/or join a specific network within a site using various methods. Some methods include signing-up for an account, following someone, and friending someone.

In addition to using a social networking site to exchange information, members may visit a social networking site for other reasons. A member may visit a site for instance to participate in an educational, entertainment, or other type of activity. For example, a social networking site member could login to a particular site to play a video game by his or herself, or to play a video game against one or more other members. Those skilled in the art will appreciate that social networking sites can be used to implement a wide range of activities.

### SUMMARY

An aspect of the disclosure relates to a wish list for a social networking site. In one embodiment, a method includes providing a first user interface having a wish list button. Upon an actuation of the wish list button, a second user interface having a wish list form is provided. Information is entered into the wish list form, and one or more vendor links that correspond to the information are identified. An electronic message that includes the one or more vendor links and the information entered into the wish list form is generated. In certain situations, a child enters the information into the wish list form, and the electronic message is sent to a parent of the child.

These and various other features and advantages that characterize the claimed embodiments will become apparent upon reading the following detailed description and upon reviewing the associated drawings.

### BRIEF DESCRIPTION OF THE DRAWINGS

FIG. 1 is a home page user interface of a social networking site.

FIG. 2 is a login user interface of a social networking site.

FIG. 3 is a profile user interface of a social networking site.

FIG. 4 is a wish list user interface of a social networking site.

FIG. 5 is an email generated in response to the creation of a wish list.

FIG. 6 is a method of generating a wish list.

FIG. 7 is a method of completing a transaction associated with a wish list.

FIG. 8 is a computing network that can be used to implement a social networking site and/or a wish list.

FIG. 9 is a computing device that can be used to implement a social networking site and/or a wish list.

### DETAILED DESCRIPTION

Certain embodiments of the present disclosure are directed towards a wish list system that can be implemented utilizing a social networking site. For instance, in one particular embodiment, a social networking site for children includes a wish list button. A child selects the wish list button, completes the wish list, and hits send. The wish list may appear to be sent to “The North Pole” or “Santa Claus,” but in actuality the wish list is sent to the child's parent. Additionally, the wish list system may direct the parent to certain vendors to purchase an item on the wish list, and/or provide the parent with an opportunity to buy an item on the wish list for a discounted price. These and various other features and advantages are described in further detail below.

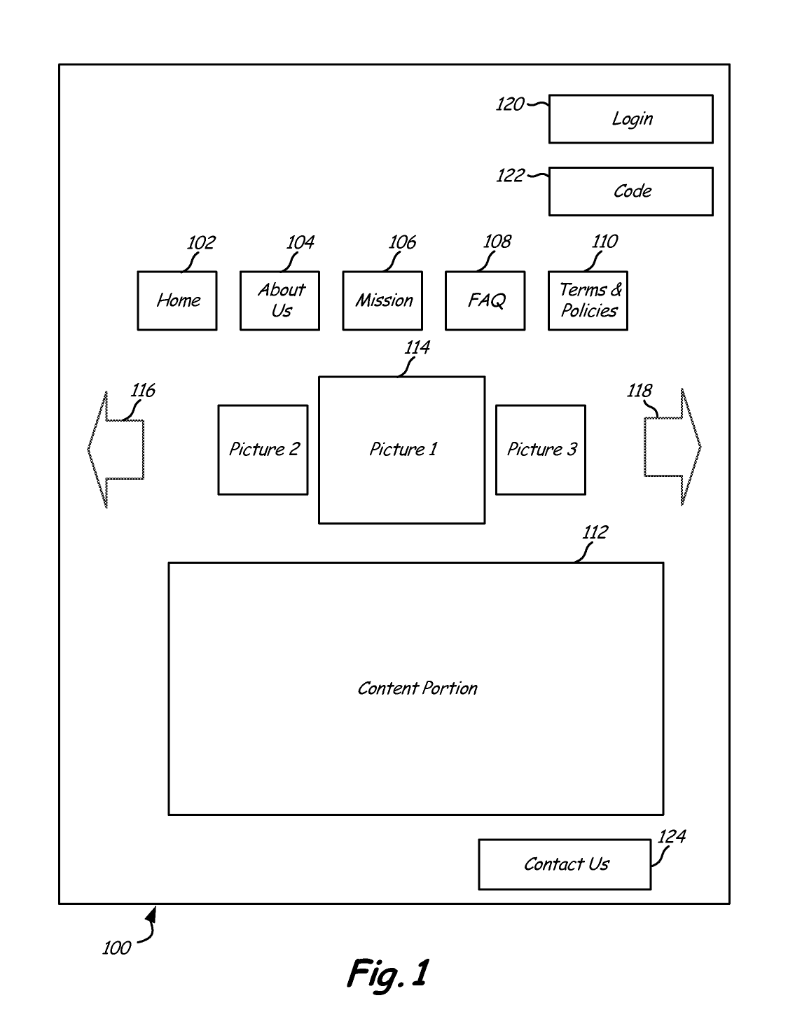

FIG. 1 is an example of a home page user interface 100 for a social networking site. Some embodiments of the present disclosure can be implemented with a social networking site such as with the one shown in the figures. However, embodiments are not limited to only the social networking site depicted in the figures, or to any social networking site. Instead, embodiments can be implemented utilizing a wide variety of different environments, and can be used in websites and applications other than the specific examples shown in the figures.

Interface 100 includes a number of information buttons 102-110 across the top of the interface. Actuation of one of the information buttons 102-110 illustratively displays different information that is relevant to the site. In one embodiment, the different information is displayed in a content portion 112. For example, actuation of home button 102 may cause a general description of the site to be displayed in content portion 112. Actuation of about us button 104 may cause further descriptive information about the site to be displayed in content portion 112. Actuation of mission button 106 may cause mission information to be displayed in content portion 112. Actuation of FAQ button 108 may cause frequently asked questions information to be displayed in content portion 112, and actuation of terms and policies button 110 may cause terms and policies information to be displayed in content portion 112.

Interface 100 may also include a number of pictures in a pictures section 114. For example, various photographs could be displayed in section 114. Interface 100 may have control buttons 116 and 118 that enable the pictures that are being displayed to be changed. For instance, actuation of button 116 may cause the pictures to rotate to the left, and actuation of button 118 may cause the pictures to rotate to the right.

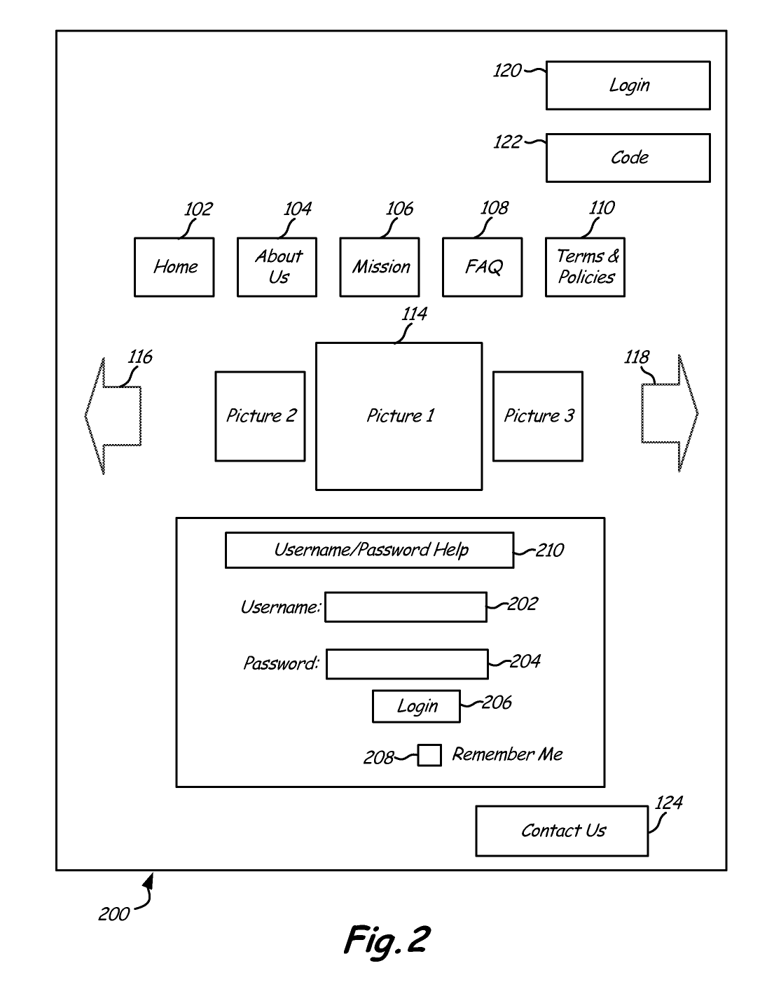

Towards the top of the page, interface 100 includes a login button 120. Actuation of login button 120 illustratively enables a member to log into the site. FIG. 2 shows an example of one dialogue box 200 that could be generated to login a member. Box 200 may include a username field 202 in which a member can type his or her username, and a password field 204 in which the member can type his or her password. The person can then select login button 206 to log into the site. Box 200 may also include a remember me box 208 to remember some or all of the login information if the site is visited again, and a username/password help button 210 in case the person needs help with either the username and/or password.

Returning to FIG. 1, next to login button 120, interface 100 optionally includes a code button 122. In one embodiment, a person or the parent of a person who is invited or tagged to join the site receives a code. For example, the parent of a child who is invited to join the site may receive a code through email. In such a case, a person who receives a code selects the code button 122 and is then able to type in the code. If the code is valid, the person may then start a process that can be used to register the child to become a member of the site.

Finally with respect to FIG. 1, interface 100 may include a contact us button 124. A person can optionally use button 124 to send an administrator or other person associated with the site a message. Additionally, it should be noted that the specific interface 100 shown in the figure is given merely for illustration purposes only, and that embodiments can of course be implemented using interfaces that differ from the specific example shown in the figure. For instance, an interface 100 is not limited to the particular features shown in the figure, and embodiments of interfaces 100 can include any other feature and/or combination of features.

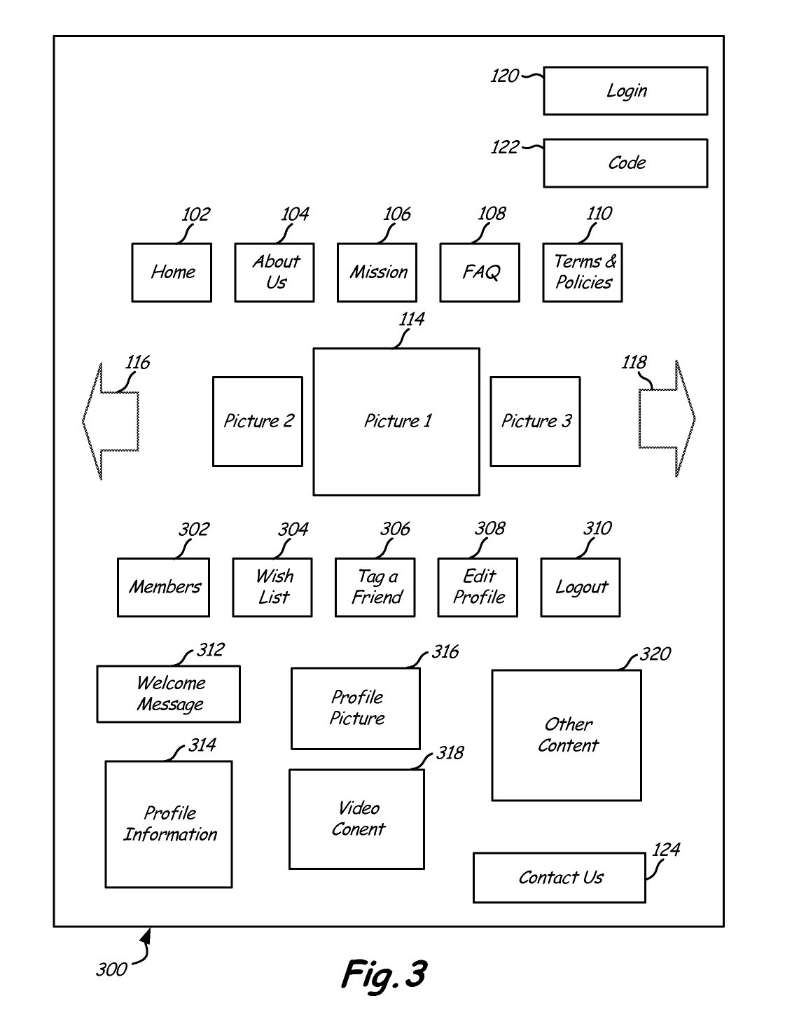

FIG. 3 is an example of a profile user interface 300. Interface 300 is illustratively generated once a member logs into the site. For example, interface 300 could be shown after a person uses login button 120 in FIG. 1 to log into the site.

Interface 300 includes a number of action buttons 302-310. For instance, interface 300 may include a members button 302, a wish list button 304, a tag a friend button 306, an edit profile button 308, and a logout button 310. Other embodiments of interface 300 can obviously include more or fewer actions buttons, and different buttons than the examples shown in the figure.

Buttons 302-310 can illustratively be used to perform a number of different actions or to complete a number of different tasks. For example, actuation of members button 302 may cause a list of members of the site to be displayed. Actuation of wish list button 304 may cause an interface to be displayed that can be used to complete a wish list. Actuation of tag a friend button 306 can be used to invite another person to become a member of the site. Actuation of edit profile button 308 can be used to edit the profile information of the person currently logged in, and logout button 310 can be used to log out the person currently logged in.

Some other examples of information that may be included within interface 300 include a welcome message 312, profile information 314, a profile picture 316, video content 318, and other content 320. Welcome message 312 illustratively welcomes the member to the site once he or she has successfully logged in. The other sections 314, 316, 318, and 320 may include information related to or about the logged in member. For example, profile information 314 may include textual information about the member. Profile picture 316 may include one or more pictures that are associated with or chosen by the member, and video content may similarly include one or more videos that are associated with or chosen by the member. In one embodiment, video content 318 is not directly uploaded to the site, but is instead linked into the site from another social networking site (e.g. YouTube, etc.). Other content section 320 is optional, and can include any other type of information that may be desirable to include in a profile page.

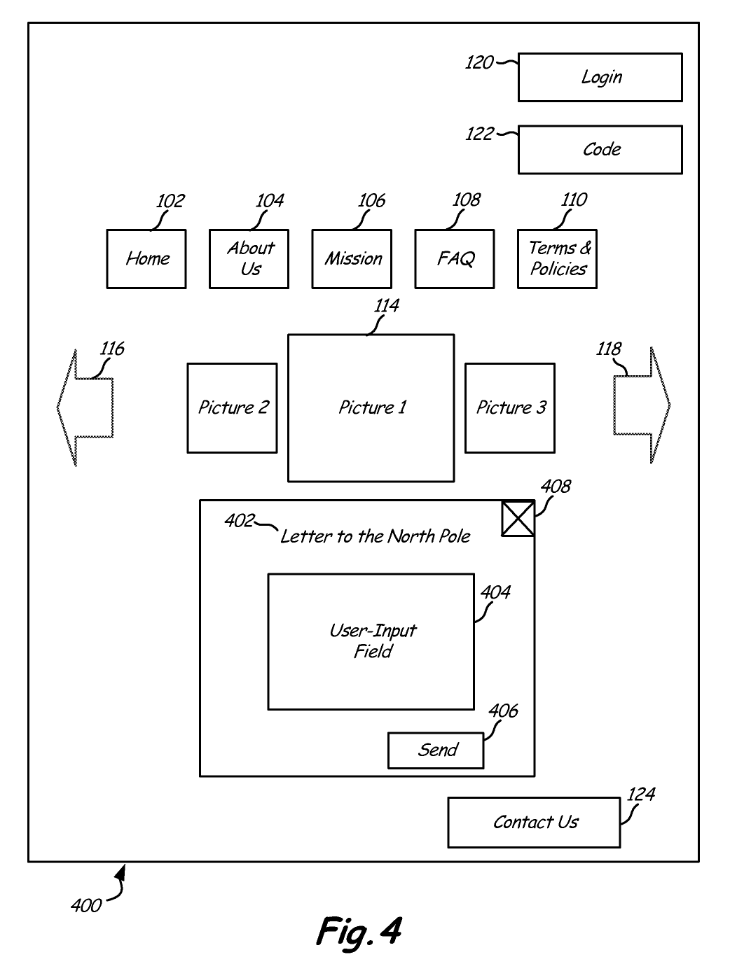

FIG. 4 shows an example of a wish list user interface 400. A wish list user interface 400 is illustratively generated or displayed upon a wish list button 304 in FIG. 3 being selected. Interface 400 optionally includes a title section 402, a user-input field 404, a send button 406, and a cancel button 408. Title section 402 can include any title or description. Some examples of possible titles could be “Letter to the North Pole” or “Letter to Santa Claus.”

User-input field 404 is a field in which a person can type in text. In one embodiment, the text may be a list or letter that includes one or more items that the person would like to have. For example, a child may type out a letter to Santa Claus in which the child lists a number of items that he or she would like to get for Christmas. Embodiments are not however limited to any particular implementation and can include other types of letters or lists that include items.

Once a person has completed entering information into field 404, he or she can select the send button 406 to have the information sent. As is discussed in further detail below, in one embodiment, the information is sent to a parent of the person completing the wish list. Accordingly, a child may get the impression that he or she is sending a wish list to the North Pole or Santa Claus, when in reality the wish list is being sent to a parent. Interface 400 may also include a cancel button 408 that can be selected if it is desired to cancel out of the wish list user interface 400 and return to a previous interface before anything is sent.

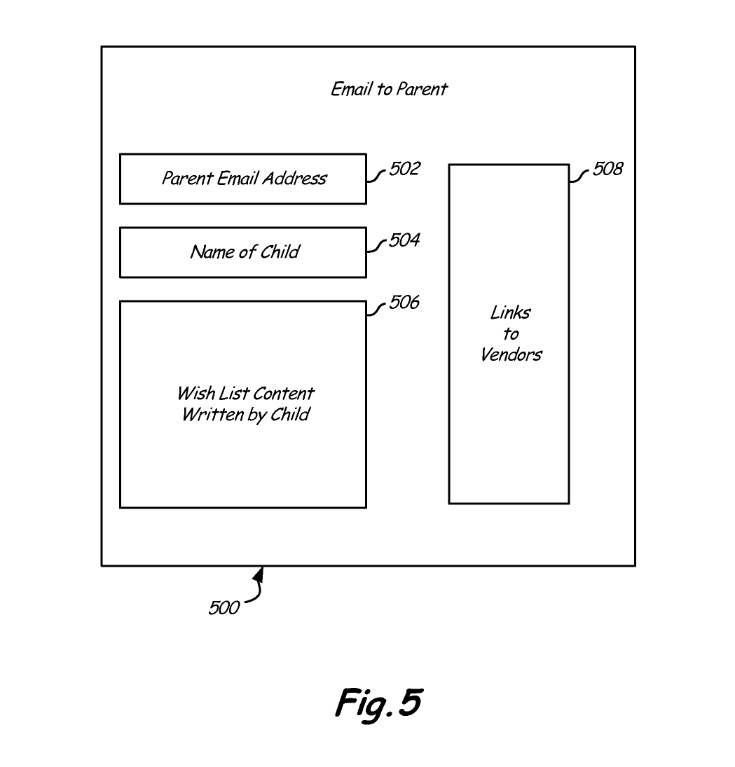

FIG. 5 is a block diagram of an email message 500 that is generated upon send button 406 in FIG. 4 being selected. Message 500 optionally includes the parent's email address 502, the name of the child generating the wish list 504, the content of the wish list 506, and one or more links to vendor sites 508. The content of the wish list 506 includes the information that was typed into the wish list input field 404 in FIG. 4. Accordingly, a parent can see the message generated by the child.

Links 508 illustratively correspond to items mentioned in the wish list content 506. For example, a child may write a wish list stating that he or she would like to get a hockey stick and a digital music player. Links 508 can include links to specific vendors' websites where the items can be purchased. The links 508 could for instance include a link to a sporting good retailer's website that sells hockey sticks, and a link to an electronics retailer's website that sells digital music players.

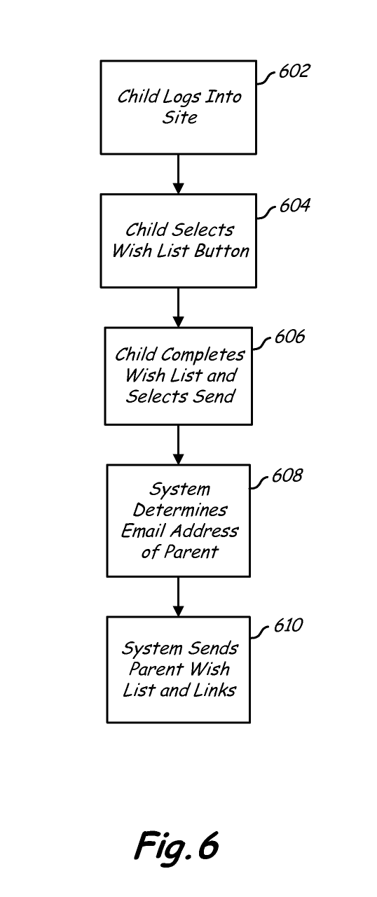

FIG. 6 is a process flow diagram of a method of implementing a wish list in a social networking site. At block 602, a child logs into a site. At block 604, the child selects a wish list button. In response to the selection of the wish list button, a wish list user interface is generated, and the child completes and sends the wish list at block 606. The system then determines the email address of a parent at block 608, and sends the parent the wish list and corresponding links at block 610.

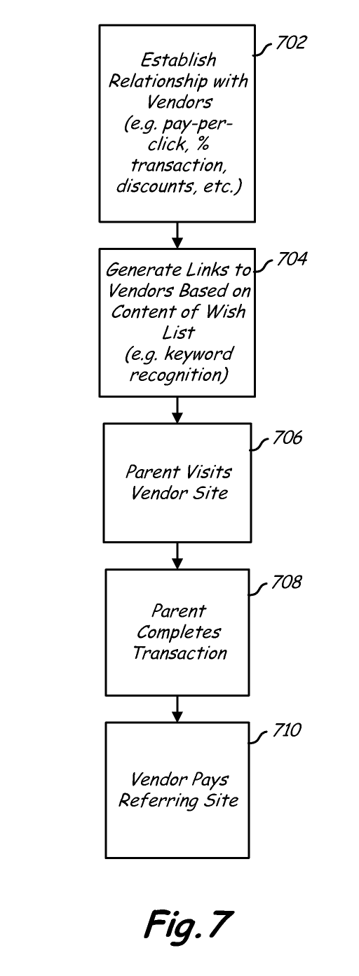

FIG. 7 is a process flow diagram of a method of completing a wish list transaction. At block 702, a social networking site establishes a relationship with one or more vendors. A social networking site and a vendor may for instance enter into a contract about how the vendor will compensate the site. A vendor could compensate a site on a pay-per-click basis. A vendor could also compensate a site by giving the site a percentage of each completed sale. Embodiments are not however limited to any specific methods of compensation, and embodiments can include any form of compensation and any method of determining the amount of compensation. Additionally, the social networking site and vendors may enter into other types of contractual agreements. A vendor could agree for example to give a discount to members of the social networking site or to people who are referred to the vendor through the social networking site.

At block 704, links to vendors are generated based on the content of a wish list. This may be accomplished by using a keyword recognition system. A keyword recognition system can for instance examine the words entered into the user-input field 404 in FIG. 4. Then, based on the included words, one or more links associated with the words is identified, and included in the email sent to the parent. This process may be automated such that the links are automatically generated and included in the email.

At block 706, a parent utilizes one of the links included in the email to visit a vendor's site. In an embodiment, the links include an identifier such that the vendor knows that the person visiting the site was referred by the social networking site. Accordingly, the vendor is able to track the amount of business that it is getting from the social networking site. Also, the vendor can use this information to calculate any pay-per-click or pay-per-transaction compensation fees that are owed to the social networking site. The vendor could further use this information to give the parent a discount or any other type of promotional offer.

At block 708, a parent completes a transaction (e.g. purchases an item associated with one of the links), and at block 710, the vendor pays the social networking site for the referral. Again, the compensation may be on a pay-per-click, pay-per-transaction, or on any other type of basis.

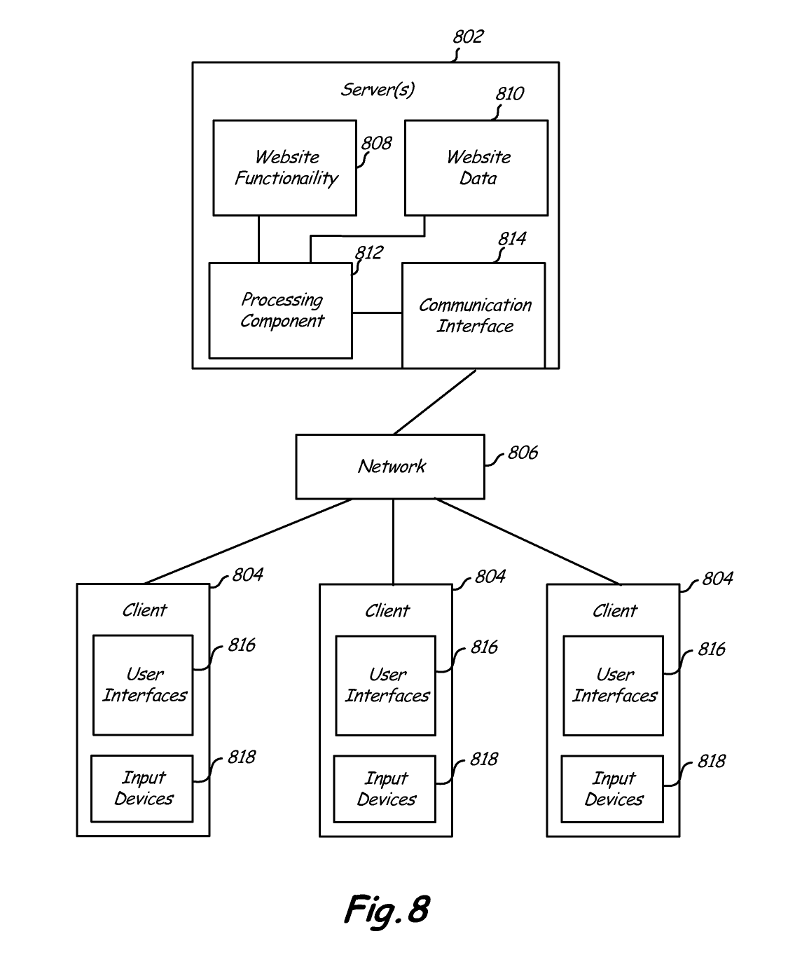

FIG. 8 is a block diagram of an example of an operating environment 800 that can be used to implement the wish list and/or social networking site described above. Embodiments are not however limited to any particular environment, and embodiments can be practiced in environments that differ from the one shown in FIG. 8.

Environment 800 optionally includes one or more servers 802 that are communicatively coupled to clients 804 utilizing a network 806. Server 802 illustratively includes a first database 808 and a second database 810. First database 808 includes data that enables the social networking site's functionality. For example, first database 808 includes data needed to implement the user interfaces shown in FIGS. 1-5. Second database 810 includes other data such as, but not limited to, data corresponding to member profiles, data corresponding to relationships with vendors, and any other data that may be needed or useful. For example, second database 810 may include pictures or any other content that a member has posted in his or her profile. Databases 808 and 810 could be implemented as one physical database, or implemented using a number of different physical databases. Server 802 may also include a processing component 812 and a communication interface 814.

Clients 804 can include any type of computing devices such as, but not limited to, personal computers, notebook computers, tablet computers, and smartphones. Clients 804 have displays that can be used to display user interfaces 816 (e.g. user interfaces 100, 200, 300, 400, and 500 in FIGS. 1-5). Clients 804 may also have input devices 818 such as, but not limited to, keyboards, mice, touchscreens, microphones, cameras, etc.

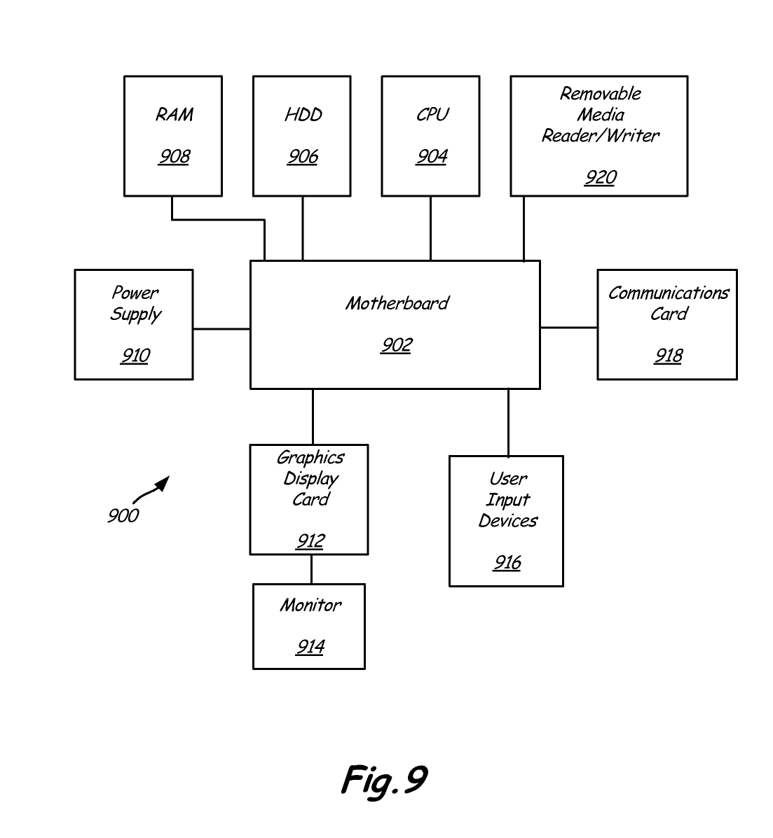

FIG. 9 is a block diagram of one specific embodiment of a computing device 900 that can be used to implement a server 802 and/or a client 804. Embodiments are however not limited to any specific computing device, and embodiments can be implemented using devices that differ from the one shown in FIG. 9.

Computing device 900 includes a motherboard 902, a central processing unit 904, a hard disk drive 906, random access memory 908, a power supply 910, a graphics display card 912, a monitor 914, user input devices 916, a communications card 918, and removable media reader/writer 920. Hard disk drive 906 is configured to write information to, and read information from computer readable storage media. Random access memory 908 is also configured to write information to, and read information from computer readable storage media. Removable media reader/writer 920 is configured to write information to, and read information from removable media such as, but not limited to, a magnetic disk, an optical disk, and/or flash memory. User input devices 916 are configured to receive various inputs from a user. Devices 916 can include, but are not limited to, a keyboard, a mouse, a touch screen, and/or a microphone. Communications card 918 enables computing device 900 to transfer data to and from other electronic devices.

Graphics display card 912 generates graphical image information and outputs the information such that it can be viewed on a monitor. Monitor 914 receives a signal from graphics display card 912 and displays visual images on its screen for a user to view. Central processing unit 904 executes computer program instructions and processes data. Motherboard 902 provides electrical and logical connections by which the other components of the system communicate. For example, motherboard 902 allows the central processing unit 904 to read data from, and write data to random access memory 908. Finally, power supply 910 provides for the electrical requirements of computing device 900. For example, electricity needed to operate hard disk drive 906 and monitor 914 illustratively originates from power supply 910.

Finally, it is to be understood that even though numerous characteristics and advantages of various embodiments have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. In addition, although the embodiments described herein are directed to social networking sites, it will be appreciated by those skilled in the art that the teachings of the disclosure can be applied to other types of sites, without departing from the scope and spirit of the disclosure.

What is claimed is:

1. A computer-implemented method for generating a wish list, the method comprising:
providing a first user interface having a wish list button;
providing, upon an actuation of the wish list button, a second user interface having a wish list form;
receiving information entered into the wish list form;
identifying one or more vendor links that correspond to the information; and
generating an electronic message that includes the one or more vendor links and the information entered into the wish list form.

2. The method of claim 1, wherein the first user interface is provided upon a user logging into a social networking site.

3. The method of claim 1, wherein a child enters the information into the wish list form, and wherein the electronic message is sent to a parent of the child.

4. The method of claim 1, and further comprising:
receiving a payment from a vendor based on a pay-per-click basis.

5. The method of claim 1, and further comprising:
receiving a payment from a vendor based on a percentage of a transaction basis.

6. The method of claim 1, and further comprising:
utilizing the one or more vendor links to receive a discounted price.

7. The method of claim 1, and further comprising:
utilizing keyword recognition to identify the one or more vendor links.

8. A computer-implemented system comprising:
a first user interface having a wish list button;
a second user interface having a wish list form that is generated upon an actuation of the wish list button; and
a third user interface having information entered into the wish list form and a vendor link that corresponds to the information.

9. The system of claim 8, wherein the first and the second user interfaces are included within a social networking site.

10. The system of claim 8, wherein the third user interface is included within an electronic mail message.

11. The system of claim 8, wherein the information entered into the wish list form includes one or more products.

12. The system of claim 11, wherein keyword recognition is utilized to identify the one or more products.

13. The system of claim 12, wherein the vendor link provides an opportunity for a user to purchase the one or more products.

14. The system of claim 13, wherein providing the opportunity for the user to purchase the one or more products includes providing the user with a discount.

15. The system of claim 8, wherein the first user interface has a tag a friend button.

16. A computer-implemented method comprising:
logging into a social networking site;
selecting a wish list button to generate a wish list form;
entering information into the wish list form; and
identifying a product based on the information entered into the wish list form.

17. The method of claim 16, and further comprising:
generating a link to a vendor's website that has the identified product.

18. The method of claim 17, and further comprising:
sending an electronic mail message that includes the link and the information entered into the wish list form.

19. The method of claim 18, wherein a child logs into the social networking site, and wherein the electronic mail message is sent to a parent of the child.

20. The method of claim 19, wherein the electronic mail message includes links to multiple vendors' websites.
